(19) United States
(12) Patent Application Publication
(10) Pub. No.: US 2016/0200912 A1
(43) Pub. Date: Jul. 14, 2016

(54) LIGHT-BLOCKING PIGMENT COMPOSITION AND LIGHT-BLOCKING MEMBER FOR DISPLAY

(71) Applicant: DIC CORPORATION, Tokyo (JP)

(72) Inventors: Kazushi SUZUKI, Sakura-shi (JP); Ryosuke ASAMI, Sakura-shi (JP); Ikuro KIYOTO, Sakura-shi (JP)

(73) Assignee: DIC Corporation, Tokyo (JP)

(21) Appl. No.: 14/912,484

(22) PCT Filed: Dec. 18, 2014
(86) PCT No.: PCT/JP2014/083585

§ 371 Date: Feb. 17, 2016

(30) Foreign Application Priority Data
Mar. 10, 2014 (JP) 2014-046305

(51) Int. Cl. C09B 67/22; G02B 1/00

(52) U.S. Cl. CPC C09B 67/0033; G02B 1/00

(57) ABSTRACT

Provided is a light-blocking pigment composition which has high insulation properties and a low dielectric constant and which can satisfy high optical density, and a light-blocking member for display, which contains the light-blocking pigment composition. When a pigment composition containing a benzimidazolone dioxazine-based pigment, a benzimidazolone-based pigment, and a carbazole dioxazine-based pigment in a specific ratio is used for a light-blocking member for display, since the light-blocking member has high insulation properties, a low dielectric constant, and high optical density, it is possible to provide a display having high light-blocking properties.

### TECHNICAL FIELD

The present invention relates to a light-blocking pigment composition which has high insulation properties, a low dielectric constant, and high optical density and which can be used for stable operation of a liquid crystal display device, and a light-blocking member for display, using the light-blocking pigment composition.

### BACKGROUND ART

In recent years, in the field of liquid crystal displays, a liquid crystal panel provided with a color filter on array (COA) in which a color filter substrate is integrated with a thin film transistor (TFT) array substrate has attracted attention. When the color filter on array is used, precise alignment to be performed in the case of using the above two substrates is not required, and each of red, blue, and green pixels in a color filter can be miniaturized up to the limit, and thus it is possible to obtain a high-definition liquid crystal panel.

Since a resin black matrix for such a color filter on array needs to have high light-blocking properties, it is required that the resin black matrix be made into a thick film. However, as the film thickness of the resin black matrix increases, the difference in the crosslink density of a portion exposed to light in a film thickness direction increases, and thus it is difficult to achieve high sensitization and obtain a black pattern having a good shape. Further, as means for high light-blocking, it has been attempted to use a large amount of a light-blocking material. However, when a conductive material, such as carbon, is used as the light-blocking material, the specific dielectric constant of the black matrix becomes high, and the volume resistance thereof is lowered, thereby causing a problem of deteriorating the reliability of a display device.

In order to solve such a problem, attempts to use a black organic pigment composition, obtained by mixing organic pigments to become black, instead of carbon black as a light-blocking material has been recently actively conducted.

PTL 1 discloses the use of a light-blocking composition containing a benzimidazolone dioxazine pigment which is used for a black matrix provides high light-blocking properties. Further, PTL 2 discloses a colored resin composition for forming a light-blocking film, which is characterized by a pseudo-blackened color mixing organic pigment including a combination of a yellow pigment, a blue pigment, and a violet pigment or a combination of a yellow pigment, a red pigment, and a blue pigment. Moreover, PTL 3 discloses an organic pigment composition for a black matrix, in which organic pigments of blue, yellow, and red pigments, each having a particular specific surface area, are mixed, and a photosensitive composition for a black matrix, including the organic pigment composition.

However, in these recent attempts, compared to a known black matrix using carbon black, there have been problems in that an optical density (OD) value is low, and it is impossible to realize light-blocking properties which can withstand practical use.

### CITATION LIST

### Patent Literature

[PTL 1] JP-A-2008-257204

[PTL 2] JP-A-9-302265

[PTL 3] JP-A-2012-32697

### SUMMARY OF INVENTION

### Technical Problem

An object of the present invention is to provide a light-blocking pigment composition which has high insulation properties and a low dielectric constant and which can satisfy high optical density, and to provide a light-blocking member for display, containing the light-blocking pigment composition.

### Solution to Problem

As a result of intensive studies in view of the circumstances, the present inventors found that, when a light-blocking pigment composition containing a benzimidazolone dioxazine-based pigment, a benzimidazolone-based pigment, and a carbazole dioxazine-based pigment, each having a specific structure, in a specific ratio is used for a light-blocking member for display, a low dielectric constant becomes and high light-blocking properties are exhibited. Based on the findings, the present invention has been completed.

The present invention provides a light-blocking pigment composition, including: from 5% by weight to 80% by weight of a benzimidazolone dioxazine-based pigment represented by General Formula (1) below; from 20% by weight to 50% by weight of a benzimidazolone-based pigment having the chemical structures of General Formula (2) and General Formula (3) below; and from 5% by weight to 80% by weight of a carbazole dioxazine-based pigment having at least one chemical structure of General Formulae (4) to (6) below.

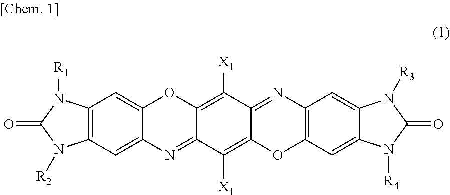

In the formula, each of R₁ to R₄ represents a hydrogen atom or a monovalent hydrocarbon group which may have a substituent, and X₁ represents a hydrogen atom or a halogen atom.

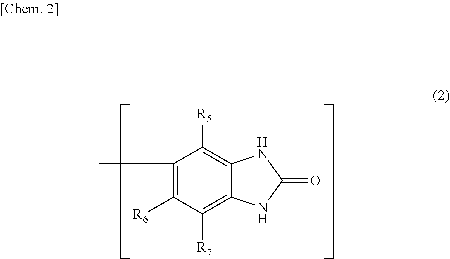

In the formula, each of R₅ to R₇ represents a hydrogen atom, a halogen atom, or a monovalent hydrocarbon group which may have a substituent.

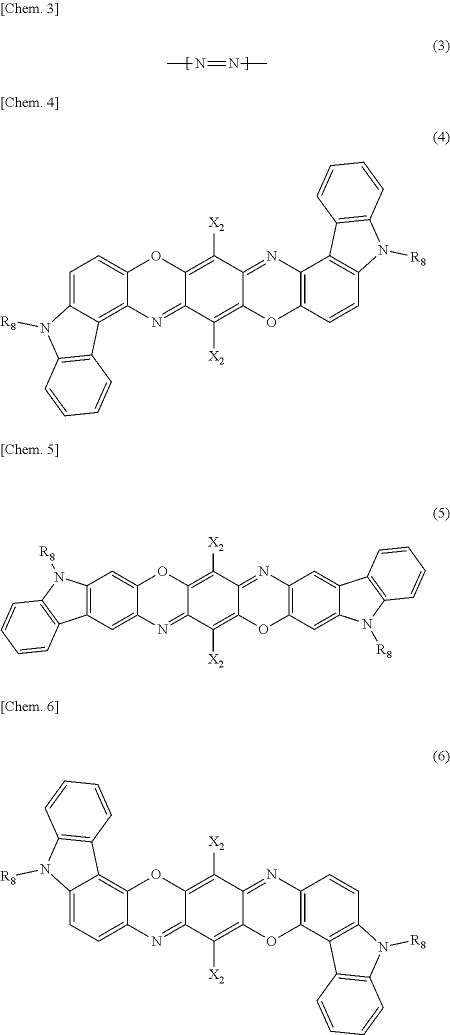

In the formulae, X₂ represents a hydrogen atom or a halogen atom, and R₈ represents a hydrogen atom or a monovalent hydrocarbon group which may have a substituent.

Further, the present invention provides the light-blocking pigment composition according to claim 1, in which the above-described benzimidazolone dioxazine-based pigment is C.I. Pigment Blue 80.

Further, the present invention provides the light-blocking pigment composition according to claim 1, in which the above-described benzimidazolone-based pigment is at least one organic pigment selected from C.I. Pigment Orange 36, C.I. Pigment Orange 60, C.I. Pigment Orange 62, C.I. Pigment Orange 64, and C.I. Pigment Orange 72.

Further, the present invention provides the light-blocking pigment composition according to claim 1, in which the above-described carbazole dioxazine-based pigment is C.I. Pigment Violet 23.

Further, the present invention provides a light-blocking member for display, including any one of the above-described light-blocking pigment compositions.

### Advantageous Effects of Invention

The light-blocking pigment composition of the present invention uses a specific benzimidazolone dioxazine-based pigment, a specific benzimidazolone-based pigment, and a specific carbazole dioxazine-based pigment in a specific ratio, thereby exhibiting a particularly remarkable technical effect of easily obtaining a light-blocking member for display, which has high insulation properties, a low dielectric constant, and high optical density.

### DESCRIPTION OF EMBODIMENTS

Hereinafter, the present invention will be described in detail.

In order to increase an OD value, that is, in order to enhance the absorption intensity of light in the entire visible light region, the light-blocking pigment composition of the present invention is required to combine pigments having different peak wavelengths of absorption intensity. Therefore, the present invention provides a light-blocking pigment composition containing a benzimidazolone dioxazine-based pigment, a benzimidazolone-based pigment, and a carbazole dioxazine-based pigment, each having a specific structure, in a specific ratio, and a light-blocking member for display, containing the light-blocking pigment composition.

The light-blocking pigment composition of the present invention contains from 5% by weight to 80% by weight of a benzimidazolone dioxazine-based pigment represented by General Formula (1) below.

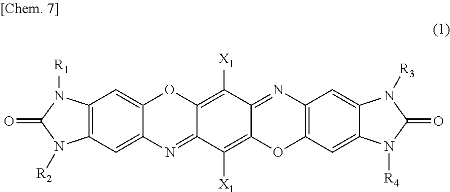

In the formula, each of R₁ to R₄ represents a hydrogen atom or a monovalent hydrocarbon group which may have a substituent, and X1 represents a hydrogen atom or a halogen atom.

A specific example of the benzimidazolone dioxazine-based pigment may include C.I. Pigment Blue 80. When the pigment composition of the present invention contains the benzimidazolone dioxazine-based pigment in an amount of from 5% by weight to 80% by weight, and preferably from 25% by weight to 70% by weight in the pigment composition, the OD value thereof is high, and, as a result, it is possible to obtain a light-blocking member for display, having high light-blocking properties.

Further, in the light-blocking pigment composition of the present invention, the benzimidazolone-based pigment is a benzimidazolone-based pigment having the chemical structures of General Formula (2) and General Formula (3) below, and, specifically, is at least one pigment selected from C.I. Pigment Orange 36, C.I. Pigment Orange 60, C.I. Pigment Orange 62, C.I. Pigment Orange 64, and C.I. Pigment Orange 72. When the pigment composition of the present invention contains the benzimidazolone-based pigment in an amount of from 20% by weight to 50% by weight, and preferably from 20% by weight to 25% by weight, the OD value thereof is high, and, as a result, it is possible to obtain a light-blocking member for display, having high light-blocking properties.

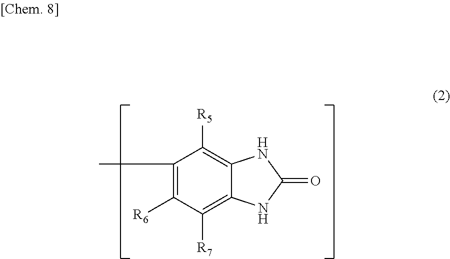

In the formula, each of R₅ to R₇ represents a hydrogen atom, a halogen atom, or a monovalent hydrocarbon group which may have a substituent.

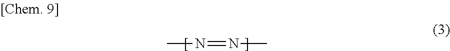

The light-blocking pigment composition contains from 20% by weight to 50% by weight of the benzimidazolone-based pigment having the chemical structures of General Formula (2) and General Formula (3) above, and further contains from 5% by weight to 80% by weight of a carbazole dioxazine-based pigment having at least one chemical structure of General Formulae (4) to (6) below.

Further, in the light-blocking composition of the present invention, the carbazole dioxazine-based pigment is a carbazole dioxazine-based pigment having the chemical structures of General Formulae (4) to (6) below, and, specifically, is C.I. Pigment Violet 23. When the pigment composition of the present invention contains the carbazole dioxazine-based pigment in an amount of from 5% by weight to 80% by weight, and preferably from 10% by weight to 50% by weight, the OD value thereof is high, and, as a result, it is possible to obtain a light-blocking member for display, having high light-blocking properties.

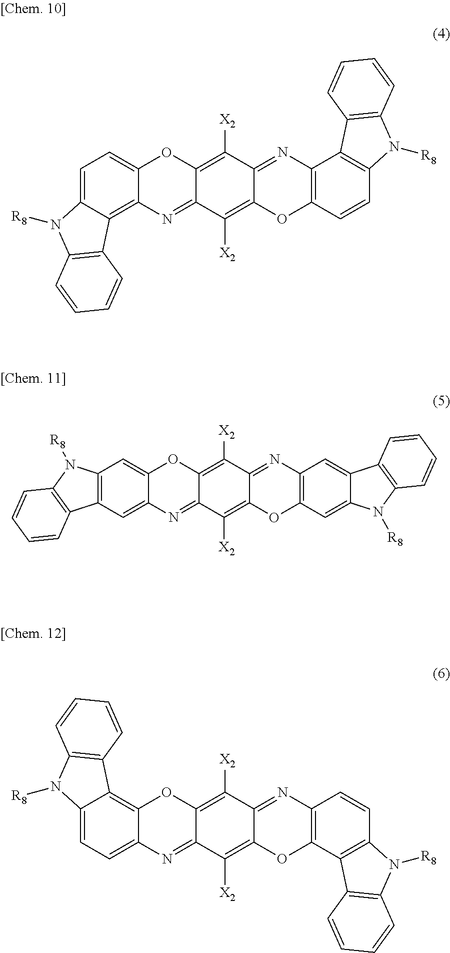

In the formulae, X₂ represents a hydrogen atom or a halogen atom, and R₈ represents a hydrogen atom or a monovalent hydrocarbon group which may have a substituent.

The light-blocking pigment composition of the present invention is a light-blocking pigment composition, which was revealed to exhibit a maximum OD value for the first time when containing from 5% by weight to 80% by weight of a benzimidazolone dioxazine-based pigment represented by General Formula (1), from 20% by weight to 50% by weight of a benzimidazolone-based pigment having the chemical structures of General Formula (2) and General Formula (3), and from 5% by weight to 80% by weight of a carbazole dioxazine-based pigment having at least one chemical structure of General Formulae (4) to (6). Unlike the pigment composition disclosed in JP-A-2008-257204, which is composed of C.I. Pigment Blue 80 or C.I. Pigment Blue 80 and at least one organic pigment selected from a yellow pigment, an orange-colored pigment, a red pigment, and a brown pigment, a maximum OD value is exhibited by the light-blocking pigment composition of the present invention, compared to a known technology.

Moreover, the light-blocking pigment composition of the present invention may also be mixed with other organic pigments or inorganic pigments so as not to impair the balance of transmittance in a visible region.

Here, the display refers to a device for displaying a video signal of a still image or a moving image output from an apparatus, such as a computer or a television. The display is also referred to as a monitor, and examples thereof include a plasma display (PDP), a liquid crystal display (LCD), an EL display (ELD), a field emission display (FED), and a crystal LED display (CLED).

Further, the light-blocking member for display according to the present invention refers to a material for blocking the light being in a visible light region or being emitted from a light-emitting member, such as a backlight of a display. Specific examples thereof include a black matrix, a TFT light-blocking film, a black mask, a black seal, a black column spacer, and a field limiting layer in ELD.

In the light-blocking pigment composition of the present invention, according to the specification of the light-blocking member for display, organic pigments may be refined and then mixed, or may be mixed and then refined.

The method of refining a pigment is not limited as long as it is a known and used method. Generally, it is possible to employ a solvent salt milling method, a sulfuric acid dissolution method, a dry grinding method, a pigmentation method by normal pressure and pressurization with an organic solvent and water, or a combination thereof.

The organic pigment composition of the present invention may be mixed with an organic dye derivative. The organic dye derivative may have any chemical structure as long as it has a sulfonic acid group or a phthalimide group or is a sulfonic acid salt. There are many cases where the organic dye derivative, which has a sulfonic acid group or a phthalimde group or is a sulfonic acid salt, is added to the organic pigment in order to improve the dispersibility of the organic pigment in a binder and solvent system, and the effects thereof are well known. The number of substituents of the sulfonic acid group per molecule is 1 to 4 and preferably 1 to 2. Since the pigment composition of the present invention is a black-based pigment composition, any organic dye derivative can be used. Specific examples thereof include an azo structure, a benzimidazolone structure, a quinacridone structure, a diketopyrrolopyrrole structure, a phthalocyanine structure, and a dioxazine violet structure. Among them, copper phthalocyanine sulfonic acid or a salt thereof, phthalimidomethyl copper phthalocyanine, quinacridone sulfonic acid or a salt thereof, and phthalimidomethyl quinacridone are preferable. The metal forming a salt with a sulfonic acid is a monovalent or divalent metal, such as Ca, Na, K, Mg, Fe, Co, Ni, Cu, or Zn. As a material forming a salt other than metal salts, there is an organic amine salt, such as an aliphatic amine (NHR₂, NH₂R, [NR₄]⁺ (R: alkyl group having 1 to 20 carbon atoms)).

The organic dye derivative is contained in an amount of 1 part to 20 parts per 100 parts of an organic pigment. Considering hue and productivity, it is preferable that the organic dye derivative is contained in an amount of 1 part to 15 parts. In regard to the timing of addition of an organic dye, the organic dye may be added during the process of refining an organic pigment, the process having been carried out in the present invention, and may also be added after cleaning and purifying an organic pigment after the refining process. However, considering the application of a dispersion effect due to the organic dye derivative which has a sulfonic acid group or is a salt thereof, it is preferable to treat the organic pigment after the refining.

As the method of treating the organic dye derivative, there is a method of preparing a dye from the organic dye derivative with a solid or an alkali and adsorbing the dye prepared from the organic dye derivative on the surface of an organic pigment in an acidic state. In the case of a solid, it is added to a wet cake containing the refined organic pigment and a solvent such as water. The preparation of dye from the organic dye derivative with an alkali is generally carried out at a pH of 8 to 12, the dye prepared from the organic dye derivative is mixed with the refined organic pigment in slurry, and then the inside of the system is generally adjusted to an acidic state, generally, a pH of 3 to 5, so as to precipitate the organic dye derivative on the surface of the organic pigment. In the preparation of the light-blocking pigment composition of the present invention, various additives may be added in addition to the organic dye derivative. Specific examples of the various additives may include a photocurable or thermosetting resin, a surfactant, a dispersant, and rosin.

A colored composition is prepared from the pigment composition of the present invention, a resin-based dispersant, and an organic solvent. In the method of preparing the colored composition, colored compositions, in which the organic pigments of respective colors, an organic solvent, and a dispersant are dispersed, may be mixed with each other, and all the organic pigments may also be dispersed in an organic solvent and a dispersant at one time.

When these pigment compositions are dispersed in an organic solvent, in order to improve dispersibility and dispersion stability, a resin-based dispersant is used in combination. The resin-based dispersant has a function of being bonded to an organic pigment and an anchoring site to allow a compatible portion to be extended in a dispersion medium so as to constitute a dispersion, and is different in kind from an alkali-soluble resin or a photopolymerizable monomer used in the preparation of a photosensitive composition to be described later.

Examples of the resin-based dispersant include resin-based dispersants having a polymer chain, such as a polyurethane resin, polyethyleneimine, polyoxyethylene glycol diester, an acrylic resin, and a polyester resin. Among these, a polyester resin-based dispersant and/or an acrylic resin-based dispersant are preferable in terms of dispersibility, heat resistance, and light resistance.

Specific examples of the various types of resin-based dispersant include AJISPER (trade name, manufactured by Ajinomoto Fine-Techno Co., Inc.), EFKA (trade name, manufactured by Ciba Co., Ltd.), DISPERBYK (trade name, manufactured by BYK Japan KK), DISPARLON (trade name, manufactured by Kusumoto Chemicals, Ltd.), SOLSPERSE (trade name, manufactured by Lubrizol Corporation), KP (trade name, manufactured by Shin-Etsu Chemical Co., Ltd.), and POLYFLOW (trade name, manufactured by KYOEISHA CHEMICAL Co., LTD.). These dispersants may be used singly, and two or more kinds thereof can be used in any combination and in any ratio.

The content of the resin-based dispersant is from 30 parts to 60 parts, and preferably from 38 parts to 50 parts per 100 parts, based on mass, of the sum of organic pigments of respective colors.

An organic solvent is used in the preparation of a colored composition.

Examples of the organic solvent used here include diisopropyl ether, mineral spirit, n-pentane, amyl ether, ethyl caprylate, n-hexane, diethyl ether, isoprene, ethyl isobutyl ether, butyl stearate, n-octane, BARSOL #2, APCO #18 solvent, diisobutylene, amyl acetate, butyl acetate, APCO thinner, butyl ether, diisobutyl ketone, methyl cyclohexene, methyl nonyl ketone, propyl ether, dodecane, SOKAL solvent No. 1 and No. 2, amyl formate, dihexyl ether, diisopropyl ketone, SOLVESSO #150, (n, sec, t-) butyl acetate, hexene, shell TS28 solvent, butyl chloride, ethyl amyl ketone, ethyl benzoate, amyl chloride, ethylene glycol diethyl ether, ethyl ortho formate, methoxy methylpentanone, methyl butyl ketone, methyl hexyl ketone, methyl isobutyrate, benzonitrile, ethyl propionate, methyl cellosolve acetate, methyl isoamyl ketone, n-amyl methyl ketone (2-heptanone), methyl isobutyl ketone, propyl acetate, amyl acetate, amyl formate, bicyclohexyl, diethylene glycol monoethyl ether acetate, dipentene, methoxymethyl pentanol, methyl amyl ketone, methyl isopropyl ketone, propyl propionate, propylene glycol-t-butyl ether, methyl ethyl ketone, methyl cellosolve, ethyl cellosolve, ethyl cellosolve acetate, carbitol, cyclohexanone, ethyl acetate, propylene glycol, propylene glycol monomethyl ether, propylene glycol monomethyl ether acetate, propylene glycol monoethyl ether, propylene glycol monoethyl ether acetate, dipropylene glycol monoethyl ether, dipropylene glycol dimethyl ether, dipropylene glycol monomethyl ether, dipropylene glycol monomethyl ether acetate, 3-methoxy propionate, 3-ethoxypropionate, methyl 3-ethoxypropionate, ethyl 3-ethoxypropionate, methyl 3-methoxypropionate, ethyl 3-methoxy propionate, propyl 3-methoxy propionate, butyl 3-methoxy propionate, diglyme, ethylene glycol acetate, ethyl carbitol, butyl carbitol, ethylene glycol monobutyl ether, propylene glycol-t-butyl ether, 3-methoxy butanol, 3-methyl-3-methoxy butanol, and tripropylene glycol methyl ether.

When a photosensitive composition for forming a black matrix by photolithography is prepared using the colored composition, in order for the photosensitive composition to be excellent in coatability, workability, an dischargeability in low viscosity, it is preferable that, at least, n-amyl methyl ketone (2-heptanone) is used as an organic solvent to be contained in the colored composition.

In order to prepare the colored composition, the organic solvent may be used singly, and two or more kinds thereof can be used in any combination and in any ratio. However, in the colored composition of the present invention, the content of the organic solvent is generally from 300 parts to 800 parts, and preferably from 400 parts to 600 parts per 100 parts, based on mass, of the sum of color organic pigments of respective colors.

In the preparation of the colored composition, if necessary, for example, various kinds of pigment derivatives can be used in combination. Examples of the substituents of the pigment derivative include a sulfonic acid group, a sulfonamide group and a quaternary salt thereof, a phthalimidemethyl group, a dialkylaminoalkyl group, a hydroxyl group, a carboxyl group, and an amide group, each of which is directly bonded to a pigment skeleton or is bonded to a pigment skeleton through an alkyl group, an aryl group, a heterocyclic group, or the like.

The colored composition can be prepared by mixing and stirring the above-described organic pigment compositions of respective colors, a resin-based dispersant, and an organic solvent. If necessary, the colored composition can be prepared by performing shaking over the required time in the presence of various grinding media, such as beads or rods, and dispersing the media by filtration or the like.

The colored composition can be used for a black matrix and a black mask of a color filter constituting a display, a column spacer and a black seal of a liquid crystal layer, a TFT light-blocking film, a field limiting layer in ELD, and other members of a display requiring the light blocking by a known method.

The typical method of preparing a color filter is a photolithography method. In the photolithography, a black matrix is obtained by a method including the steps of: applying the following photosensitive composition prepared from the colored composition of the present invention onto a transparent substrate for a color filter; heating and drying (prebaking) the applied photosensitive composition; performing pattern exposure by irradiating the prebaked photosensitive composition with ultraviolet light through a photomask to cure a photocurable compound of a portion corresponding to a black matrix portion; and developing an unexposed portion with a developer and removing a non-pixel portion to fix a pixel portion to the transparent substrate. In the method, a black matrix portion composed of the cured colored film of the photosensitive composition is formed on the transparent substrate. Each pixel portion of RGB can also be formed from the photosensitive composition prepared from organic pigments of respective colors having a larger specific surface area similarly to the above-described manner.

Examples of the method of applying the photosensitive composition to be described later onto a transparent substrate, such as a glass substrate include a spin coating method, a roll coating method, a slit coating method, and an ink jet method.

The drying conditions of the coating film of the photosensitive composition applied on the transparent substrate are changed depending on the kind of each component, a combination ratio, and the like, but are generally at 50° C. to 150° C. for about 1 to 15 minutes. The heat treatment is generally referred to as a “prebake”. Further, as the light used in the photocuring of the photosensitive composition, ultraviolet light having a wavelength range of 200 nm to 500 nm or visible light is preferable. Various light sources emitting the light having the wavelength range can be used.

Examples of the developing method include a puddle method, a dipping method, and a spray method. After the exposure and development of the photosensitive composition, the transparent substrate, on which a black matrix or a pixel portion having necessary colors is formed, is washed with water and dried. The color filter obtained in this way is heat-treated (post-baked) by a heating device, such as a hot plate or an oven, at 100° C. to 280° C. for a predetermined time to remove volatile components in the colored coating film and to thermally cure the unreacted photocurable compound remaining in the cured colored film of the photosensitive composition, thereby completing the color filter.

The photosensitive composition for forming a black matrix portion of a color filter can be prepared by mixing essential components including the colored composition of the present invention, an alkali-soluble resin, a photopolymerizable monomer, and a photopolymerization initiator.

When the colored resin film for forming a black matrix portion needs toughness capable of withstanding baking performed in the actual production of a color filter, in order to prepare the photosensitive composition, it is essential that not only the polymerizable monomer but also the alkali-soluble resin is used in combination. When the alkali-soluble resin is used in combination, an organic solvent capable of dissolving the alkali-soluble resin is preferably used.

As the method of preparing the photosensitive composition, a method of previously preparing the colored composition of the present invention and then adding an alkali-soluble resin, a photopolymerizable monomer, and a photopolymerization initiator thereto to obtain a photosensitive composition is generally used.

Examples of the alkali-soluble resin used in the preparation of the photosensitive composition include resins containing a carboxyl group or a hydroxyl group exhibiting acidity, such as a novolak type phenol resin, a (meth)acrylic acid alkyl ester-(meth)acrylic acid copolymer, a styrene-(meth)acrylic acid copolymer, and a styrene-maleic acid copolymer. In the present invention, the term “(meth)acrylic” collectively refers to acrylic and methacrylic.

Among them, in order to further increase the heat resistance of the cured film, it is preferable to use an alkali-soluble resin containing each polymerization unit of an imide structure, styrene, and (meth)acrylic acid.

Unlike the above-described resin, the alkali-soluble resin does not have a function of being bonded to an organic pigment and an anchoring site to allow a compatible portion to be extended in a dispersion medium so as to constitute a dispersion. However, on the other hand, the alkali-soluble resin is exclusively used in order to remove the unexposed portion of the photosensitive composition by taking advantage of its characteristics of dissolving when coming into contact with alkali.

Examples of the photopolymerizable monomer include di-functional monomers, such as 1,6-hexanediol di(meth)acrylate, ethylene glycol di(meth)acrylate, neopentyl glycol di(meth)acrylate, triethylene glycol di(meth)acrylate, bis[(meth)acryloxyethoxy] bisphenol A, and 3-methyl-pentanediol di(meth)acrylate; multi-functional monomers having a relatively small molecular weight, such as trimethylolpropane tri(meth)acrylate, pentaerythritol tri(meth)acrylate, tris(2-hydroxyethyl)isocyanurate tri(meth)acrylate, dipentaerythritol hexa(meth)acrylate, dipentaerythritol penta(meth)acrylate, and ditrimethylolpropane tetra(meth)acrylate; and multi-functional monomers having a relatively large molecular weight, such as polyester acrylate, polyurethane acrylate, and polyether acrylate. Similarly to the above description, the term “(meth)acrylate” collectively refera to acrylate and methacrylate.

Among them, in order to further increase the heat resistance of the cured film, it is preferable to use tetra-functional to hexa-functional (meth)acrylates.

Examples of the photopolymerization initiator include acetophenone, benzophenone, benzyl dimethyl ketanol, benzoyl peroxide, 2-chloro thioxanthone, 1,3-bis(4′-azidebenzal)-2-propane, 1,3-bis(4-azidebenzal)-2-propane-2′-sulfonic acid, 4,4′-diazidestilbene-2,2′-disulfonic acid, ethanone-1-[9-ethyl-6-[2-methyl-4-(2,2-dimethyl-1,3-dioxolanyl)methoxybenzoyl]-9.H.-carbazol-3-yl]-1-(O-acetyloxime).

However, since the photosensitive composition of the present invention is black, it is preferable to use a photopolymerization initiator excellent in curability.

When an alkali-soluble resin not affecting light transmittance and a photopolymerizable monomer are selected, the cured film of the photosensitive composition can have a maximum light transmittance of 1% or less in a wavelength range of 400 nm to 800 nm and a light transmittance of 80% in a near-infrared region having a wavelength range of 800 nm to 1100 nm, which are suitable for a black matrix.

The light transmittance of a black matrix refers to light transmittance of a black matrix (cured film) having a film thickness of 3 μm formed on a transparent substrate, such as a glass substrate, measured by using a spectrophotometer, in comparison to the substrate on which a resin black matrix is not formed.

The maximum light transmittance means the greatest value in the light transmittance in a specific wavelength region (range). More specifically, the maximum light transmittance is the maximum value of a light transmittance curve in a specific wavelength region. For example, the case where “the maximum light transmittance in a wavelength range of 400 nm to 800 nm is 1% or less” means that the maximum value of a light transmittance curve in a wavelength range of 400 nm to 800 nm is 1% or less, and there is no region of which light transmittance is more than 1% in this range.

On the other hand, the “wavelength 800 nm to 1100 nm” means a so-called near-infrared region. The “black matrix having a light transmittance of 80% or more in the near-infrared region of wavelength of 800 nm to 1100 nm” refers to a black matrix having low light absorptivity and high light transmittance in the near-infrared wavelength region.

The higher the light transmittance in the near-infrared region, it is the easier for the black matrix to dissipate the heat generated from a TFT element which is a heat generating source. Therefore, an increase in on-current and off-current in the TFT element is also reduced, and it is difficult to cause a thermal runaway.

If the volume resistivity is set to 1×10¹³ Ω·cm or more and the dielectric constant is set to 5 or less, the short circuit of the TFT element (switching element composed of a thin film transistor) due to leakage current can be reduced, the switching of the TFT element can be accurately transferred, and the disturbance of driving of liquid crystal can also be reduced.

The volume resistivity is a criterion of insulation properties of a material, and is electrical resistance per unit volume. For example, the volume resistivity can be measured by a method described in the “University Lectures of the Institute of Electrical Engineers of Japan, Electrical and electronic material—from the basic to the test method—” from the Institute of Electrical Engineers of Japan (pages 223 to 230, 2006, Ohmsha, Ltd.).

The dielectric constant means a so-called specific permittivity, and is a ratio of the dielectric constant of a material and the dielectric constant of vacuum. For example, the dielectric constant can be measured by a method described in the “University Lectures of the Institute of Electrical Engineers of Japan, Electrical and electronic material—from the basic to the test method —” from the Institute of Electrical Engineers of Japan (pages 233 to 243, 2006, Ohmsha, Ltd.).

With respect to the photosensitive composition of the present invention having such characteristics, 3 parts to 20 parts of the sum of an alkali-soluble resin and a photopolymerizable monomerper 100 parts of the colored composition of the present invention, 0.05 parts to 3 parts of a photopolymerization initiator per 1 part of the photopolymerizable monomer, and, if necessary, the organic solvent used in the preparation of the above-described colored composition are added and stirred to be dispersed uniformly, so that a photosensitive composition for forming a black matrix portion can be obtained.

In the formation of a black matrix by photolithography, in order for the photosensitive composition of the present invention to have a low viscosity which brings about excellent coatability and workability, it is preferable to prepare the photosensitive composition such that, at least, the content of non-volatile components is from 5% to 20% based on mass.

As the developer, it is possible to use a commonly known alkali aqueous solution. Particularly, since the photosensitive composition contains an alkali-soluble resin, the washing with the alkali aqueous solution is effective in the formation of a black matrix portion. The excellent heat resistance of the photosensitive composition of the present invention is exhibited in the method of preparing a color filter in which baking is performed after such alkali washing.

Although the method of preparing a black matrix portion by photolithography has been described in detail with respect to a pigment dispersion method, a color filter may be prepared in such a manner that the black matrix portion to be prepared using the photosensitive composition of the present invention is formed by other methods, such as an electrodeposition method, a transfer method, a micelle electrolysis method, and a photovoltaic electrodeposition (PVED) method.

The color filter can be obtained by a method in which the photosensitive compositions of respective colors obtained by using a red organic pigment, a green organic pigment, a blue organic pigment, and the colored composition of the present invention is used, the space between a pair of transparent electrodes in parallel to each other is sealed with a liquid crystal material, each of the transparent electrodes is divided into discontinuous fine sections, and simultaneously color filter colored pixel portions having any one color selected from red (R), green (G), and blue (B) are alternately provided in a pattern in each of the fine sections divided in a reticular pattern by a black matrix on the transparent electrode, or can be obtained by a method in which transparent electrodes are provided after color filter colored pixel portions are formed on a substrate.

The black matrix portion obtained from the photosensitive composition of the present invention is configured to contain the above-described blue, yellow, and red organic pigments to appear black. At first glance, it is presumed to obtain a black matrix similar to the case of preparing a black photosensitive composition by mixing photosensitive compositions of respective colors. However, in the present invention, at the time of preparing a colored composition, which is a previous step of forming a photosensitive composition, organic pigments of respective colors are mixed in advance, and, as a result, more uniform mixing is achieved, and a black matrix having superior characteristics is obtained.

Hereinafter, the present invention will be described in more detail with reference to Examples and Comparative Examples. In the following Examples and Comparative Examples, both “parts” and “%” are based on mass.

### EXAMPLES

### Example 1

### Preparing Process of Colored Composition

0.2 mmφ to 0.3 mmφ of zirconia beads were added to a mixture of 3.75 parts of Pigment Blue 80 (synthesized based on JP-A-11-335575, colorant), 3.75 parts of PV FASTORANGE H4GL (Pigment Orange 72, manufactured by Clariant Japan K.K, colorant), 7.5 parts of FASTOGEN SUPER VIOLET RN-SU-02 (Pigment Violet 23, manufactured by DIC Corporation, colorant), 4.5 parts of PB-821 (polyester resin-based dispersant, manufactured by Ajinomoto Fine-Techno Co., Inc.), and 73.75 parts of propylene glycol monomethyl ether acetate, followed by dispersing with a paint conditioner for two hours, so as to obtain a colored composition (A-1).

<Preparing Process of Photosensitive Resin Composition>

100 parts of the colored composition (A-1), 5 parts of a methacrylic acid/mono(2-methacryloyloxyethyl) succinate/N-phenylmaleimide/styrene/benzyl methacrylate copolymer (copolymerization mass ratio=25/10/30/20/15, Mw=12,000, Mn=6,500) as an alkali-soluble resin, 10 parts of dipentaerythritol hexaacrylate as a photopolymerizable monomer, 1 part of ethanone-1-[9-ethyl-6-[2-methyl-4-(2,2-dimethyl-1,3-dioxolanyl)-methoxybenzoyl]-9.H.-carbazol-3-yl]-1-(O-acetyloxime) as a photopolymerization initiator, and 25 parts of dipropylene glycol dimethyl ether, 25 parts of propylene glycol monomethyl ether acetate, 75 parts of 3-methoxy-butyl acetate, and 50 parts of cyclohexanone, as an organic solvent, were mixed, so as to obtain a photosensitive resin composition (X-1).

<Preparing Process of Black Matrix>

A glass substrate of 10 cm square (glass plate “OA-10” for color filter, manufactured by Nippon Electric Glass Co., Ltd.) was dipped into a solution of a silane coupling agent “KBM-603” (manufactured by Shin-Etsu Chemical Co., Ltd.) which is diluted to 1%, for 3 minutes, washed with water for 10 seconds, water-drained by an air gun, and then dried in an oven at 110° C. for 5 minutes. The photosensitive resin composition (X-1) prepared as above was applied onto the glass substrate using a spin coater. The applied photosensitive resin composition (X-1) was vacuum-dried for 1 minute, and then heated and dried on a hot plate at 90° C. for 90 seconds, so as to obtain a coating film having a dried film thickness of about 3.5 μm. Thereafter, from the side of the coating film, two types of exposures of image exposure (pattern 1) carried out through a fine line pattern mask having a fine line width of 15 μm and entire surface exposure (pattern 2) carried out without the mask were performed. Each of the exposures was performed under a condition of using a 3 kw high-pressure mercury lamp at 50 mJ/cm² (i-line reference). Next, shower development was carried out under a water pressure of 0.15 Mpa at 23° C. using a developer composed of an aqueous solution containing 0.05% of potassium hydroxide and 0.08% of a nonionic surfactant (“A-60”, manufactured by Kao Corporation), the development was stopped with pure water, and then washing was carried out by a water-washing spray, so as to obtain a black matrix (B-1). Here, the shower development time was adjusted between 10 seconds and 120 seconds, and was 1.5 times the time taken to dissolve and remove the unexposed coating film.

### Example 2

A colored composition (A-2) was prepared under the same condition as in Example 1, except that the content of Pigment Blue 80 of Example 1 was changed to 10.5 parts, the content of PV FASTORANGE H4GL of Example 1 was changed to 3 parts, and the content of FASTOGEN SUPER VIOLET RN-SU-02 of Example 1 was changed to 1.5 parts. A black matrix (B-2) was prepared in the same manner as in Example 1, except that the colored composition (A-1) was replaced by the colored composition (A-2).

### Example 3

A colored composition (A-3) was prepared under the same condition as in Example 1, except that the content of Pigment Blue 80 of Example 1 was changed to 4.5 parts, the content of PV FASTORANGE H4GL of Example 1 was changed to 6.0 parts, and the content of FASTOGEN SUPER VIOLET RN-SU-02 of Example 1 was changed to 4.5 parts. A black matrix (B-3) was prepared in the same manner as in Example 1, except that the colored composition (A-1) was replaced by the colored composition (A-3).

### Example 4

A colored composition (A-4) was prepared under the same condition as in Example 1, except that the content of Pigment Blue 80 of Example 1 was changed to 1.5 parts, the content of PV FASTORANGE H4GL of Example 1 was changed to 3 parts, and the content of FASTOGEN SUPER VIOLET RN-SU-02 of Example 1 was changed to 10.5 parts. A black matrix (B-4) was prepared in the same manner as in Example 1, except that the colored composition (A-1) was replaced by the colored composition (A-4).

### Example 5

A colored composition (A-5) was prepared under the same condition as in Example 1, except that PV FASTORANGE H4GL of Example 1 was changed to CROMOPHTAL ORANGE GP (Pigment Orange 64, prepared by Ciba Speciality Co., Ltd.). A black matrix (B-5) was prepared in the same manner as in Example 1, except that the colored composition (A-1) was replaced by the colored composition (A-5).

### Example 6

A colored composition (A-6) was prepared under the same condition as in Example 1, except that PV FASTORANGE H4GL of Example 1 was changed to NOVOPERM ORANGE H5G 70 (Pigment Orange 62, manufactured by Clariant Japan K.K). A black matrix (B-6) was prepared in the same manner as in Example 1, except that the colored composition (A-1) was replaced by the colored composition (A-6).

### Example 7

A colored composition (A-7) was prepared under the same condition as in Example 1, except that PV FASTORANGE H4GL of Example 1 was changed to HOSTAPERM ORANGE HGL (Pigment Orange 60, manufactured by Clariant Japan K.K). A black matrix (B-7) was prepared in the same manner as in Example 1, except that the colored composition (A-1) was replaced by the colored composition (A-7).

### Example 8

A colored composition (A-8) was prepared under the same condition as in Example 1, except that PV FASTORANGE H4GL of Example 1 was changed to SYMULER FAST ORANGE 4183H (Pigment Orange 36, manufactured by DIC Corporation). A black matrix (B-8) was prepared in the same manner as in Example 1, except that the colored composition (A-1) was replaced by the colored composition (A-8).

### Comparative Example 1

A colored composition (A-9) was prepared under the same condition as in Example 1, except that the colorants of Example 1 were changed to 15 parts of Pigment Blue 80. A black matrix (B-9) was prepared in the same manner as in Example 1, except that the colored composition (A-1) was replaced by the colored composition (A-9).

### Comparative Example 2

A colored composition (A-10) was prepared under the same condition as in Example 1, except that the colorants of Example 1 were changed to 15 parts of PV FASTORANGE H4GL. A black matrix (B-10) was prepared in the same manner as in Example 1, except that the colored composition (A-1) was replaced by the colored composition (A-10).

### Comparative Example 3

A colored composition (A-11) was prepared under the same condition as in Example 1, except that the colorants of Example 1 were changed to 15 parts of FASTOGEN SUPER VIOLET RN-SU-02. A black matrix (B-11) was prepared in the same manner as in Example 1, except that the colored composition (A-1) was replaced by the colored composition (A-11).

### Comparative Example 4

A colored composition (A-12) was prepared under the same condition as in Example 1, except that the colorants of Example 1 were changed to 7.5 parts of Pigment Blue 80 and 7.5 parts of PV FASTORANGE H4GL. A black matrix (B-12) was prepared in the same manner as in Example 1, except that the colored composition (A-1) was replaced by the colored composition (A-12).

### Comparative Example 5

A colored composition (A-13) was prepared under the same condition as in Example 1, except that the colorants of Example 1 were changed to 7.5 parts of Pigment Blue 80 and 7.5 parts of FASTOGEN SUPER VIOLET RN-SU-02. A black matrix (B-13) was prepared in the same manner as in Example 1, except that the colored composition (A-1) was replaced by the colored composition (A-13).

### Comparative Example 6

A colored composition (A-14) was prepared under the same condition as in Example 1, except that the colorant of Example 1 was changed to 7.5 parts of PV FASTORANGE H4GL and 7.5 parts of FASTOGEN SUPER VIOLET RN-SU-02. A black matrix (B-14) was prepared in the same manner as in Example 1, except that the colored composition (A-1) was replaced by the colored composition (A-14).

<Evaluation>

The OD values of black matrices prepared in Examples and Comparative Examples, each of which was calculated based on OD value of Example 1, which is set at 100, are listed in Table 1 below.

TABLE 1

| | | Kind and combination amount (% by weight) of | | | | | | |
|---|---|---|---|---|---|---|---|---|
| | OD | colorant | | | | | | |
| | value | B-80 | O-72 | O-64 | O-62 | O-60 | O-36 | V-23 |
| Example 1 | 100 | 25 | 25 | — | — | — | — | 50 |
| Example 2 | 106 | 70 | 20 | — | — | — | — | 10 |
| Example 3 | 98 | 30 | 40 | — | — | — | — | 30 |
| Example 4 | 94 | 10 | 20 | — | — | — | — | 70 |
| Example 5 | 95 | 25 | — | 25 | — | — | — | 50 |
| Example 6 | 89 | 25 | — | — | 25 | — | — | 50 |
| Example 7 | 92 | 25 | — | — | — | 25 | — | 50 |
| Example 8 | 92 | 25 | — | — | | | 25 | 50 |
| Comparative | 61 | 100 | — | — | — | — | — | — |
| Example 1 | | | | | | | | |
| Comparative | 38 | — | 100 | — | — | — | — | — |
| Example 2 | | | | | | | | |
| Comparative | 54 | — | — | — | — | — | — | 100 |
| Example 3 | | | | | | | | |
| Comparative | 81 | 50 | 50 | — | — | — | — | — |
| Example 4 | | | | | | | | |
| Comparative | 74 | 50 | — | — | — | — | — | 50 |
| Example 5 | | | | | | | | |
| Comparative | 71 | — | 50 | — | — | — | — | 50 |
| Example 6 | | | | | | | | |

From the above, it was clearly found that, compared to Comparative Example 1 containing only C.I. Pigment Blue or Comparative Examples 4 to 6 each containing two kinds of pigments, the OD value of the black matrix obtained from the pigment composition of the present invention is improved compared to that of a black matrix in the related art.

1. A light-blocking pigment composition, comprising:
from 5% by weight to 80% by weight of a benzimidazolone dioxazine-based pigment represented by General Formula (1) below;
from 20% by weight to 50% by weight of a benzimidazolone-based pigment having chemical structures of General Formula (2) and General Formula (3) below; and
from 5% by weight to 80% by weight of a carbazole dioxazine-based pigment having at least one chemical structure of General Formulae (4) to (6) below: 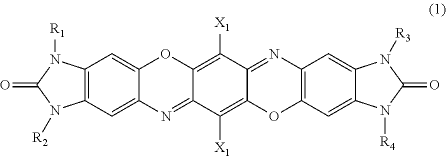
wherein each of R₁ to R₄ represents a hydrogen atom or a monovalent hydrocarbon group which may have a substituent, and X₁ represents a hydrogen atom or a halogen atom; 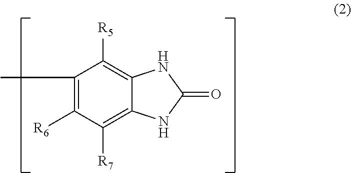
wherein each of R₅ to R₇ represents a hydrogen atom, a halogen atom, or a monovalent hydrocarbon group which may have a substituent; and 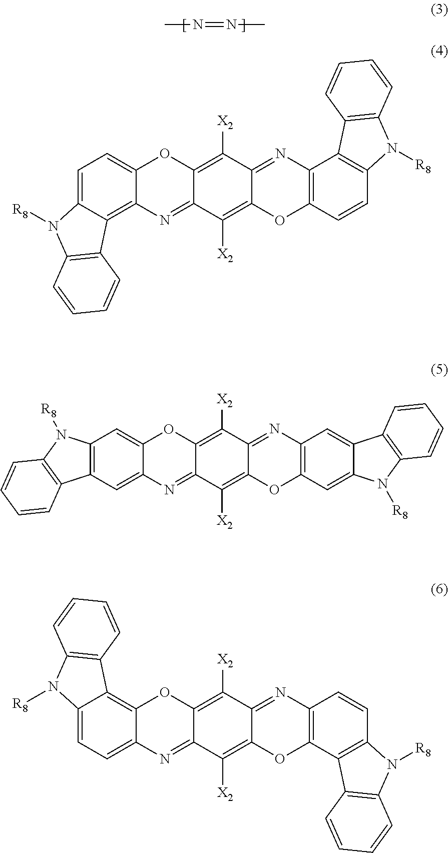
wherein X₂ represents a hydrogen atom or a halogen atom, and R₈ represents a hydrogen atom or a monovalent hydrocarbon group which may have a substituent.

2. The light-blocking pigment composition according to claim 1, wherein the benzimidazolone dioxazine-based pigment is C.I. Pigment Blue 80.

3. The light-blocking pigment composition according to claim 1, wherein the benzimidazolone-based pigment is at least one organic pigment selected from C.I. Pigment Orange 36, C.I. Pigment Orange 60, C.I. Pigment Orange 62, C.I. Pigment Orange 64, and C.I. Pigment Orange 72.

4. The light-blocking pigment composition according to claim 1, wherein the carbazole dioxazine-based pigment is C.I. Pigment Violet 23.

5. A light-blocking member for display, comprising the light-blocking pigment composition according to claim 1.
